(19) United States
(12) Patent Application Publication
(10) Pub. No.: US 2002/0031755 A1
(43) Pub. Date: Mar. 14, 2002

(54) System and method for testing students

(76) Inventors: Pei-hwa Lo, Ramsey, NJ (US); James Goodwin, Ramsey, NJ (US); Edward Lizzul, Astoria, NY (US)

Correspondence Address: Patent Law & Venture Group, Suite K-105, 3151 Airway Ave., Costa Mesa, CA, 92626, US

(21) Appl. No.: 09/874,101

(22) Filed: Jun. 4, 2001

Related U.S. Application Data
(60) Provisional application No. 60/208,850, filed on Jun. 2, 2000.

(51) Int. Cl. G09B 3/00

(52) U.S. Cl. 434/351

(57) ABSTRACT

A method for testing students comprises updating a database in a host computer by entering relevant user information, establishing wave energy communication between the host computer and a plurality of a handheld device, registering user presence by entering user identification information in the handheld devices, presenting a set of test questions comprising a test to the handheld devices from the host computer, receiving answers to the test questions, analyzing individual test results, group test results, and accumulated test results for each individual one of the handheld devices and groups of the handheld devices.

The present invention claims the priority date of a prior filed provisional patent application having ser. No. 60/208,850 and an official filing date of Jun. 2, 2000 and which discloses substantially the same material as described herein.

### BACKGROUND OF THE INVENTION

1. Field of the Invention

This invention relates to an apparatus and method of use implemented by software and executed by a host computer to interactively transmit and receive messages from a group of handheld radio frequency (RF) interface devices in a classroom or training room environment.

2. Description of Related Art

The following art defines the present state of this field:

Lemelson et al., U.S. Pat. No. 5,823,788 describes a interactive instructional system including a microprocessor-controlled base station for use by an instructor and/or a computer and a plurality of input devices each for use by a student. The base station and input devices communicate over a communication link or network employing wires, optical fibers, radio links, infrared links or the like. Each input device is in the form of a multiple keyswitch operated device which the student may operate to respond to a question posed by the instructor, computer or base station during a lecture. Each input device is also provided with an identifier code. Responses by the student are transmitted to the base station in messages, each of which further includes an identifier code thereby identifying the answering device or student. The base station receives the student' responses from the input devices and generates information for display to the instructor, including selected class and individual statistics, the base station using the identifier code to associate each response to a student. The base station may provide the information to the instructor so that, during a lecture or course, instructional material and techniques can be adjusted based on the feedback information as to how well the class and individual students are learning the subject matter. Since this system can be used continuously during a lecture or course (instead of relying on tests only a few times during a course), the instructor can continuously tailor the course to the learning speed of the class.

Cutler et al., U.S. Pat. No. 5,842,871 describes an electronic teaching system containing two principal components: a projection frame and a hand-held remote unit. The projection frame mediates the electronic test and holds a transparency on an overhead projector so that the transparency may be projected for an entire class to view. Typically the transparency features a series of questions and possible answers to the questions. The projection frame asks the questions and displays the results of the testing process. In a preferred embodiment the projection frame bears a series of pointers, one for each question. When a given question is asked, the corresponding pointer becomes illuminated. Students participate in the test by matching the correct answer to the appropriate question. The students use the second component of the present invention, the hand-held remote unit which bears a keyboard, to answer the question currently being asked by the projection frame. The hand-held remote unit and the projection frame are in wireless communication so that the projection frame is able to respond to the student' answers by indicating correctness of the answers and by awarding points for correct answers.

Siefert, U.S. Pat. No. 5,904,485 describes a computer-assisted education system, in which a school curriculum is stored in computer repositories. A learning profile is maintained for every student, which indicates the student's capabilities, preferred learning style, and progress. Based on the profile, an Intelligent Administrator (IA) selects appropriate material for presentation to the student during each learning session. The IA then assesses whether the student has mastered the material. If not, the material is presented in a different way. If repeated different presentations fail to instill mastery, the IA establishes a video conference between the student and a professor.

Hoehn-Saric et al., U.S. Pat. No. 5,915,973 describes a system for controlling the administration of remotely proctored, secure examinations at a remote test station, and a method for administering examinations. The system includes a central station, a registration station and a remote testing station. The central station includes (a) storage device for storing data, including test question data and verified biometric data, and (b) a data processor, operably connected to the storage device, for comparing test taker biometric data with stored, verified biometric data. The remote test station includes (a) a data processor, (b) a data storage device, operably connected to the data processor, for storing input data, (c) a biometric measurement device for inputting test taker biometric data to the processor, (d) a display for displaying test question data (e) an input for inputting test response data to the processor, (f) a recorder for recording proctoring data of a testing event, and (g) a communication link for communicating with the central station, for receiving test question data from the central station, and for communicating test taker biometric data, test response data, and proctoring data to the central station. Verification of the test taker and validation of the results can be performed either before or after the testing event.

Samph et al., U.S. Pat. No. 5,204,813 describes a computer-controlled portable testing device and process providing for administering a test to a user. The testing device includes an information storage medium for storing information such as test questions and the user's answers to the test questions. The test questions may include screening questions directed to the character of the user as part of a licensing issuing process and the user's answers will include answers to the screening questions. A display on the device displays information such as the test questions from the information storage medium to the user. A touch screen on the device enables the user to input selected predetermined input information by touching entry pads displayed on the display. A microprocessor is provided to control the transfer of information between the information storage medium, the display and the touch screen. An internal power source supplies power for the device. Pursuant to the computer executed process, a test item is displayed on the display. Each test item includes a question, associated answer-options to the test question, and answer entry pads corresponding to the answer-options. Once an entry pad has been touched, the answer-option corresponding to such answer entry pad is stored in a response file in the information storage medium. Function entry pads are also displayed to control the display of information. Function entry pads enable specific questions to be marked for later review and also enable the subsequent review of skipped questions.

Stevens, III U.S. Pat. No. 5,769,643 describes an instruction communication network which employs low-cost cordless telephone technology to broadcast information to students. A first computer operated by a student includes a first cordless telephone transceiver. A second computer operated by a teacher transfers instruction data to the first computer and includes a second cordless telephone transceiver. The cordless telephone transceivers preferably operate at frequencies designated by the FCC and has a transmission range less than five thousand feet. A typical frequency of operation is in a frequency band near 900 MHz. The first computer may encrypt responses to the instruction data.

Sweitzer et al., U.S. Pat. No. 6,018,617 describes a method and system for generating and formatting information, specifically test questions, in a desirable and predetermined manner. The system has dynamic-content and dynamic-presentation capabilities so that a wide variety of test problems and, ultimately, tests which consist of test problems can be created. The system includes a data processor such as a personal computer having a means for storing at least one computer program and a means for printing indicia such as a laser printer. The software component of the system includes an authoring tool which is used to create generalized expressions of a problem. A variation rules module or engine stores the variations rules which are a language for describing how to create varying questions from the generalized expression or definition of and a problem created in the authoring tool. Then another component of the software, the print engine interprets the variation rules and produces screen displays or printed tests.

Burstein et al, U.S. Pat. No. 6,115,683 describes a system for carrying out a content-based process for automatically scoring essays is disclosed. The system includes a computer; a data storage device; a parse tree file stored in the data storage device, the parse tree file being representative of an essay in a parse tree format; a morphology stripping program; a concept extraction program for creating, on the basis of a morphology-stripped parse tree file, a phrasal node file; and a rule matching scoring program for scoring the essay on the basis of the phrasal node file.

The prior art teaches the use of interactive educational systems and method but does not teach the specific structural and operational features of the instant invention.

### SUMMARY OF THE INVENTION

The present invention teaches certain benefits in construction and use which give rise to the objectives described below.

An effective two-way short-range RF apparatus is made to facilitate test and survey taking in a face-to-face environment. The invention significantly reduces workload for teacher or facilitator. It increases the effectiveness of teaching or training by getting instant test feedback. It also reduces student' anxiety waiting for test result. Computer based training and teaching becomes an important part of the learning process for school students as well as corporate employees and executives. Face to face instruction in the classroom or conference room setting is still the most effective method. It allows direct teacher-student interactions and facilitates peer discussions. To evaluate student progress, a quiz or survey is an effective means to provide feedback to an instructor. Unlike existing polling devices which survey audience responses only, the present invention interactive system provides instructions, questions or comments to attendees and communicates responses and answers to questions. A set of software that resides in the host computer or is loaded through the Internet is enabled for monitoring test progress in real time and instantly analyzes responses and reports group as well as individual results. This software technique not only saves an instructor or facilitator time and effort in grading tests but also identifies the strengths and weaknesses of a class or group as a whole. The students receive confidential test results immediately after a test is completed avoiding the long wait that is traditionally a frustration.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a summary block diagram of the preferred embodiment of the invention;

FIG. 2 is a flow diagram of a test monitor module software thereof;

FIG. 3 is a flow diagram of a test management module software thereof;

FIG. 4 is block diagram of a base station thereof;

FIG. 5 is a block diagram of a wireless interactive keypad thereof; and

FIG. 6 is a control diagram of the apparatus of FIG. 5.

### DETAILED DESCRIPTION OF THE INVENTION

The above described drawing figures illustrate the present invention in at least one of its preferred embodiments, which is further defined in detail in the following description.

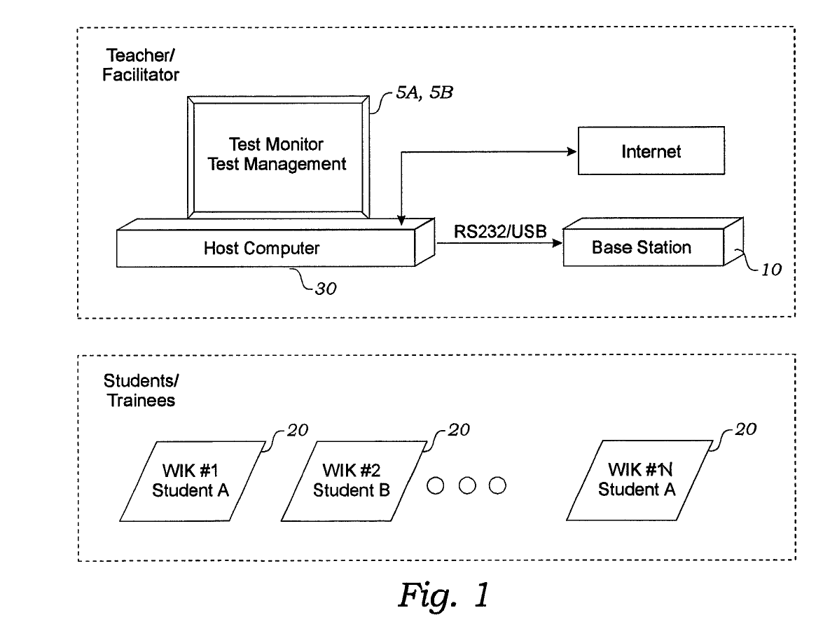

The present invention is a communications system comprising software modules, a base station 10 and one or more handheld devices 20. The handheld devices 20 shall be referred to as Wireless Interactive Keypad units (WIK units). The primary function of the WIK units 20 is to facilitate an automated and paperless test held in a classroom. They can also be used to survey or prioritize opinions from group participants in a face to face meeting. A summary block diagram illustrating the relationship between the several elements of the present invention is shown in FIG. 1. The base station 10 is connected to a host computer 30 either through RS232 or USB interface structures, which are well known interface means in the art. The base station 10 can also be controlled offsite through the Internet or similar network. The host computer 30, software modules 5 and base station 10 serve as a central message broadcast and receiver system. The WIK units 20 receive messages from the base station 10 and also transmit requested information to the base station 10; in other words, the base station 10 acts as an interface between the WIK units 20 and the host computer 30.

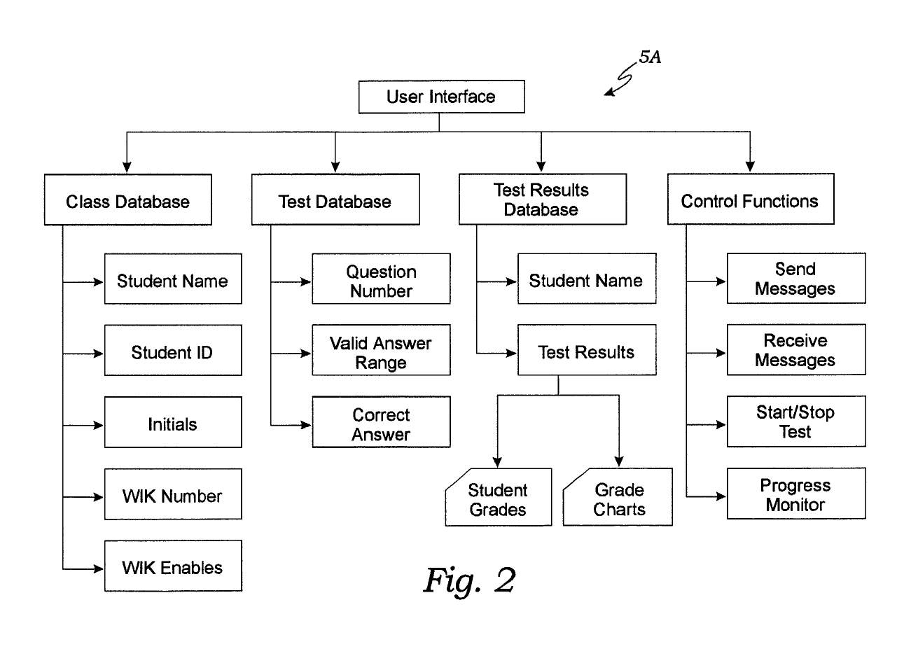

A test monitor software module 5A performs message tracking and database maintenance functions. A class instructor or meeting facilitator updates a database by entering relevant attendee (user) information such as name, social security number, student/employee identity number, WIK unit 20 serial number and so on. Users are able to register their presence by entering their personal identification information or a WIK unit 20 serial number. The test monitor software module 5A controls, prioritizes and validates all message flow. The host computer 30, through a base station communication protocol delivers person specific or broadcast messages to the users. The host computer 30, through the base station 10 also acquires responses such as questions and answers from each user. The acquired responses are stored in a database. The test module software module 5A is defined in FIG. 2.

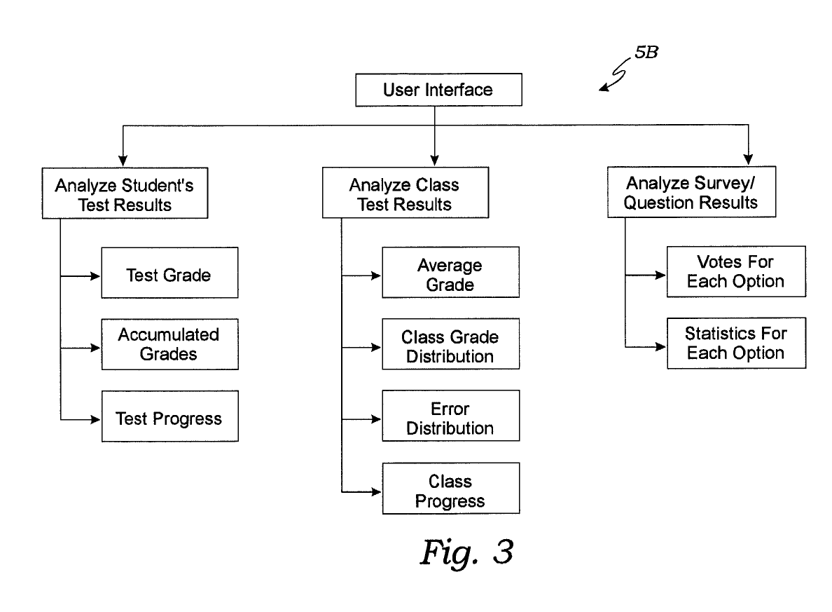

A test management software module 5B performs test result analyses. The functions performed are analysis of user test result, analysis of group test results, and analysis of accumulated test results for individual users and groups of users. The test management module 5B is defined in FIG. 3.

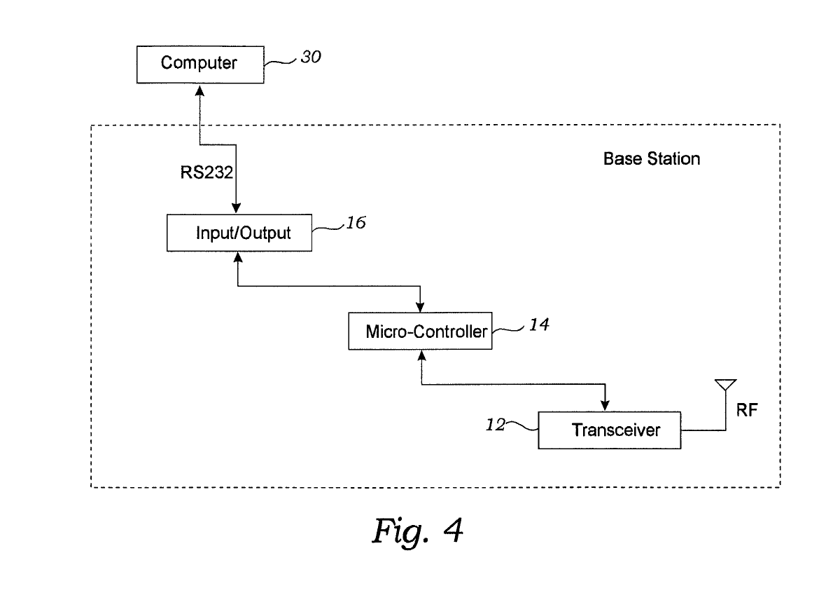

The base station 10 consists of a low power RF transceiver 12, microprocessor 14 and its peripheral circuits and a host computer interface module 16. The RF transceiver 12 transmits and receives messages between the base station 10 and each of the WIK units 20, which may number as many as 50 units. The microprocessor 14 formats each message that is received from the host computer, with a prefix, receiver address and message body, and forwards them to the addressed WIK unit 20. Each WIK unit 20 has its own uniquely encoded address. Only those WIK units 20 with the correct receiving address are able to receive each transmitted message. Therefore, at any instant of time, there is only one WIK unit 20 receiving a message from the base station 10. Similarly, at any instant in time, there is only one WIK unit 20 able to transmit a message to the base station 10. The advantage of this communication protocol is that RF interference is limited. More importantly, the base station 10 is able to transmit and receive private (individual) messages from each WIK unit 20. The microprocessor 14 also processes each message by performing error checking and ASCII formatting, well known methods. The processed messages are sent to the host computer 30 for further data processing. A block diagram of the base station 10 is illustrated in FIG. 4.

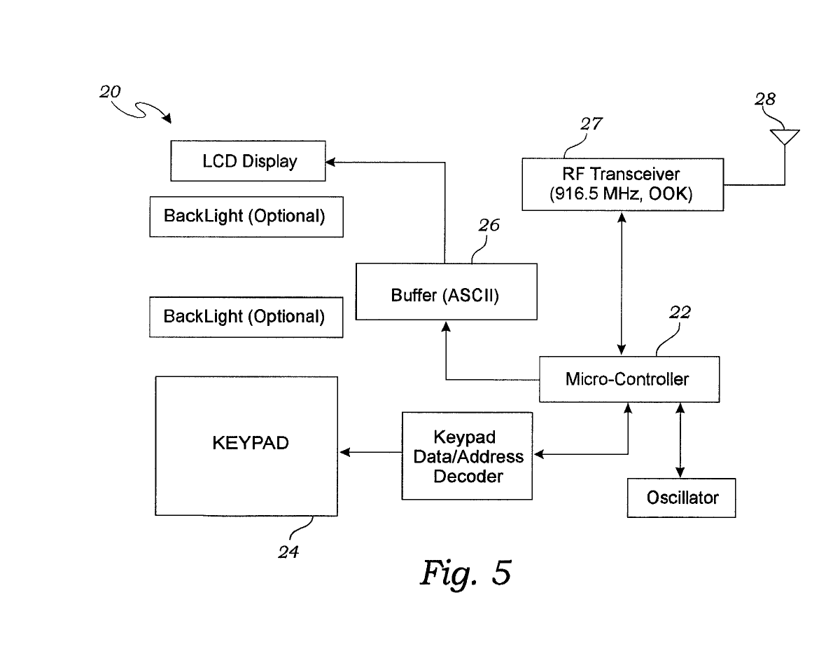

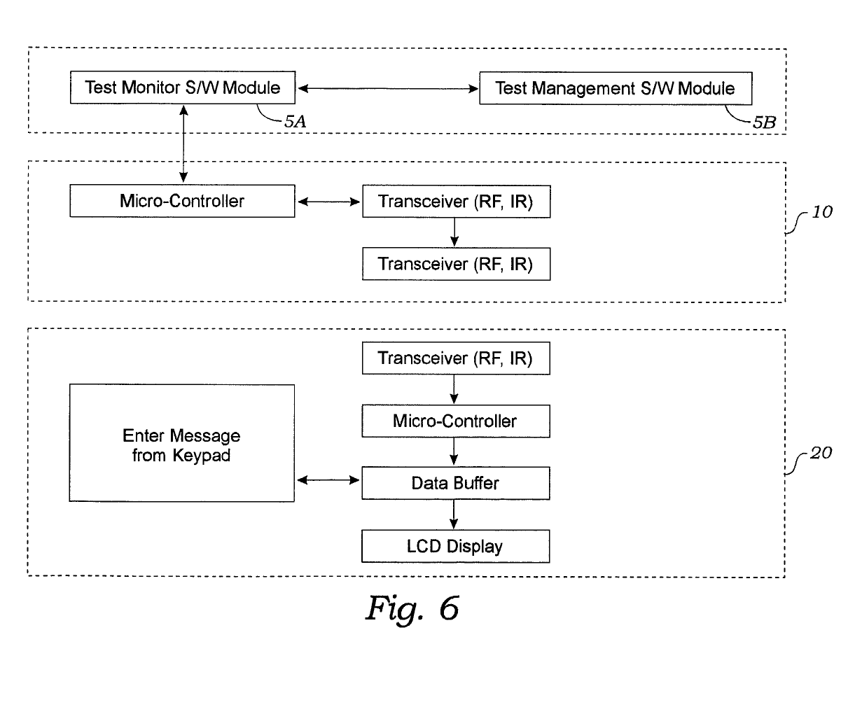

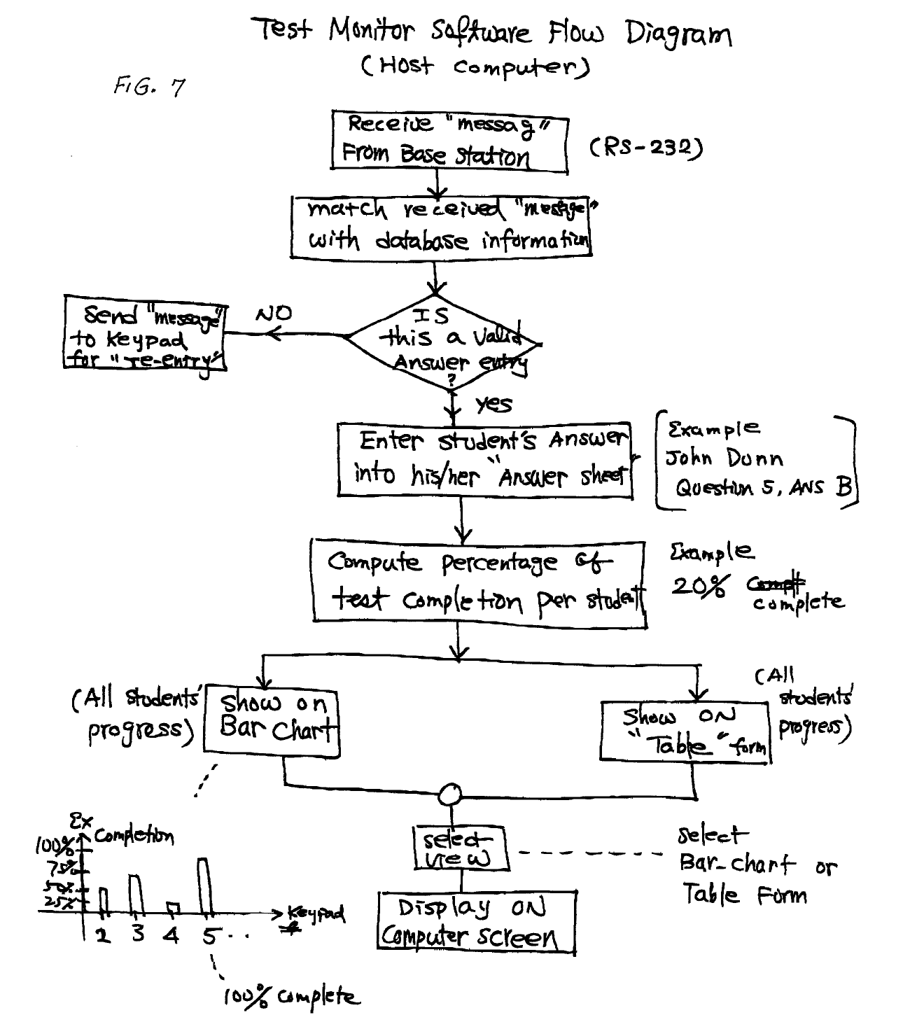

The WIK units 20 have two operational modes; listening mode, and local mode. A microcontroller 22 in the WIK unit 20 controls these operational modes. While in the listening mode, the WIK unit 20 waits for it to be polled by the base station 10. It can either display a received message from the base station 10 or transmit a local message such as a question number and answer to the base station 10. While in the local mode, the WIK unit 20 acquires and processes data from its input device 24 such as a keypad or keyboard. The WIK unit 20 can transmit a message only when the base station 10 polls it and it is in the listening mode. For example, the WIK unit 20 can transmit a particular question number and its answer to the base station 10 when in the listening mode. The WIK unit 20 can also receive a confirmation message or reminder message such as the amount of time left on a test. The WIK unit 20 will scan the input device 24 for any input message when it is in the local mode. The scanned message is then stored in a data buffer 26 before it is transmitted to the base station 10. Special protocols or mechanisms are implemented to force the WIK unit 20 to switch from local to listening mode when necessary. In one embodiment, a local timer sets up a pre-determined time-out limitation. If there is no input activity for a period of time, the WIK unit 20 switches itself from local mode to listening mode in order to receive any update information before it resumes local mode operation. The WIK unit 20 is preferably battery operated and thus highly portable. A block diagram of the WIK unit 20 is illustrated in FIG. 5.

After powering-on the WIK units 20, the Test Monitor Software Module 5A sends a message to the base station 10. The microcontroller 14 in the base station 10 formats the message and transmits it, via the RF transceiver 12. All WIK unit transceivers 27 receive the base station message via antennas 28.

If the WIK unit 20 is in the local mode, the received message is ignored. An example of this case could be when a student is composing an answer to a question. When the student answers the question by pressing a send key, the WIK unit 20 automatically assumes the listening mode. The answer is then sent to the microcontroller 22 which checks the address and performs error checking prior to transmission via antenna 28. The base station 10 acknowledges receiving the answer. During this time, the WIK unit 20 remains in the listening mode. If the message contains the correct address, it is sent to the LCD display data buffer 26. The message is then displayed on the LCD display 25, see FIG. 5. A number of methods can be used in switching the operational modes. One method is to switch the operational mode by the received message. In this approach the received message instructs the receiving WIK unit 20 to return to local mode. Another method is to switch the operational mode by time limitation set by the microcontroller. These methods and others are all acceptable mode-switching protocols in the implementation of the present invention. Through his/her WIK unit 20, the user answers a question posted by the host computer 10 or that is presented on a test paper by entering an answer through the keypad or keyboard 24. The entered answer also latches into the data buffer 26 and appears on the LCD display 25. This reminds the user about the answer posted. When the answer is satisfactory, the user then presses the send key on the keypad or keyboard 24. The answer is then transmitted to the base station 10. The base station microcontroller 14 checks the correctness of the received message and sends it to the host computer 30 through the data bus. The test monitor software module 5A receives the answer and identifies the sender's address. The answer is logged into the database under the identification number.

Until a test is completed, the captured answers are transferred into the test management system software module 5B. When the test is complete the software 5B grades each student's test results and provide a grade score either on a single test or accumulated tests bases. Test statistics are also provided and may include a student's standing in class and other results.

The above description defines the use of RF wave energy transmission. However, where appropriate, other wave energy forms such as infrared light energy and sonic waves may prove to be preferably and should be considered to be alternate embodiments of the present invention.

As an example of the method of the present invention, the steps of the method of monitoring a student test comprises the steps: receiving student wireless signals at a base station from student communication devices; inputting the student signals to a host computer; matching the student signals with student data stored in a database of the host computer; determining if the signals contain valid answers to test questions; requesting reentry of student signals if the answers are not valid; storing student answers; computing percentage of correct answers for each of the students; providing a choice of graphical views of the student answers; and displaying the student answers in graphical form a display device. See FIG. 7.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A student testing apparatus comprising a host computer, a base station and a plurality of handheld devices, where the base station 10 is connected to the host computer by an interface structure and the handheld devices are connected to the base station by a wave energy communication means, the base station providing a test monitor software enabled for message tracking, database maintenance and message prioritizing and validation; the base station providing a test management software enabled for test result analyses, analysis of user test result, analysis of group test results, and analysis of accumulated test results for individual users and groups of users; the base station further providing an interface device, a microcontroller and a transceiver, each of the handheld devices providing an input device, a microcontroller, a display buffer and display enabled for reading and displaying data held in the display buffer and a transceiver.

2. The apparatus of claim 1 wherein each of the handheld devices is enabled with a unique address.

3. The apparatus of claim 1 wherein each of the handheld devices is enabled to assume an operating mode and a listening mode and further enabled for assuming the listening mode until prompted to assuming the operating mode.

4. The apparatus of claim 1 wherein each input device of the handheld devices is a keypad and the display device is enabled for displaying a received message from the base station and for displaying a message derived from the input device.

5. A method for testing students comprising the steps of: updating a database in a host computer by entering relevant user information, establishing wave energy communication between the host computer and a plurality of a handheld device, registering user presence by entering user identification information in the handheld devices, presenting a set of test questions comprising a test to the handheld device from the host computer, analyzing individual test results, group test results, and accumulated test results for individual one of the handheld devices and groups of the handheld devices.

6. The method of claim 5 further comprising the step of providing a base station in communication between the host computer and the plurality of handheld devices.

7. The method of claim 6 further comprising the step of formatting communications between the host computer and the handheld devices in the base station.

8. The method of claim 7 wherein the formatting comprises inserting a prefix, receiver address and message body.

9. The method of claim 6 further comprising the steps of establishing two operational modes in the handheld devices, a listening mode, and local mode, the listening mode forming a default state waiting to be polled by the base station.

10. The method of claim 9 further comprising the step of transmitting a message from the handheld device only when the base station polls it and it is in the listening mode.

11. The method of claim 10 further comprising the step of setting a pre-determined timeout limitation for setting the handheld device into the listening mode.

12. The method of claim 10 further comprising the step of switching the handheld device to the listening mode when a message is received.

13. The method of claim 5 further comprising the steps of: answering a question posted by the host computer by entering an answer through a keypad, latching a data buffer and displaying the answer on an LCD display; pressing a send key on the keypad; transmitting the answer to the base station; checking correctness of the received answer at the base station; sending the answer to the host computer; identifying the address of the handheld device; and logging the answer into a database at the host computer under the identification number.

14. A method of monitoring a student test comprising the steps: receiving student wireless signals at a base station from student communication devices; inputting the student signals to a host computer; matching the student signals with student data stored in a database of the host computer; determining if the signals contain valid answers to test questions; requesting reentry of student signals if the answers are not valid; storing student answers; computing percentage of correct answers for each of the students; providing a choice of graphical views of the student answers; and displaying the student answers in graphical form a display device.
